(19) United States
(12) Patent Application Publication
(10) Pub. No.: US 2005/0279586 A1
(43) Pub. Date: Dec. 22, 2005

(54) Shaft pit equipment for an elevator

(75) Inventors: Julien Maury, Emmenbrucke (CH); Mario Fernandes, Mulhouse (FR)

Correspondence Address: BUTZEL LONG;DOCKETING DEPARTMENT, 100 BLOOMFIELD HILLS PARKWAY, SUITE 200, BLOOMFIELD HILLS, MI, 48304, US

(73) Assignee: Inventio AG

(21) Appl. No.: 11/126,681

(22) Filed: May 11, 2005

(30) Foreign Application Priority Data
May 19, 2004 (EP) 04405311.4

(51) Int. Cl. B66B 5/16

(52) U.S. Cl. 187/359

(57) ABSTRACT

Shaft pit equipment connects a guide rail and a buffer support with a plate that produces a stiff unit of the buffer support and the guide rail. The plate has a rectangular recess that fits on the narrow side of the guide rail. The plate can be pushed onto a free limb of the guide rail. The recess has on both sides of the free limb an offset that serves for conducting away the lubricating oil, wherein the lubricating oil passes into a lubricating oil collector below the plate. In addition, the plate has in the rail region a bent-over portion at which a screw is arranged. The plate is fixed in the “Y” direction by the screw, in the “Z” direction by the recess and in the “X” direction by the buffer support.

### BACKGROUND OF THE INVENTION

The present invention relates to shaft pit equipment with at least one buffer support and buffer for an elevator car or a counterweight, wherein the buffer support and the buffer introduce the forces, which arise in the case of a buffer travel, into the shaft pit, and with at least one guide rail, which is supported in the shaft pit, for the elevator car or the counterweight, wherein the rail forces which arise can be introduced into the shaft pit.

Buffer supports with buffers for the elevator car or the counterweight are arranged in the shaft pit and introduce the forces, which arise in the case of a buffer travel, into the shaft pit. The buffer carriers are designed to be bulky in correspondence with the load to be conducted away. Guide rails, which, for example, carry an elevator drive, are usually supported in the shaft pit, whereby the forces are introduced into the shaft pit. The guide rails are designed to be bulky in correspondence with the load to be borne.

It is disadvantageous with the known equipment that the buffer support and the guide rail are dimensioned independently of one another.

### SUMMARY OF THE INVENTION

The shaft pit equipment according to the present invention meets the object of avoiding the disadvantages of the known equipment and of dimensioning the buffer support in common with the guide rail.

The advantages achieved by the present invention are that the buffer support together with the guide rail forms a stiff unit. Moreover, it is advantageous that the spacing between the buffer support or the buffer and the guide rail is predeterminable by the equipment according to the present invention, whereby in turn the assembly time can be shortened. Moreover, the equipment according to the present invention promotes lubricating oil outflow in the direction of a lubricating oil collector.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a schematic fragmentary perspective view of a shaft pit with a supported guide rail and a buffer support with a buffer according to the present invention; and

FIG. 2 is an enlarged exploded perspective view showing details of the connection between the guide rail and the buffer support.

### DESCRIPTION OF THE PREFERRED EMBODIMENT

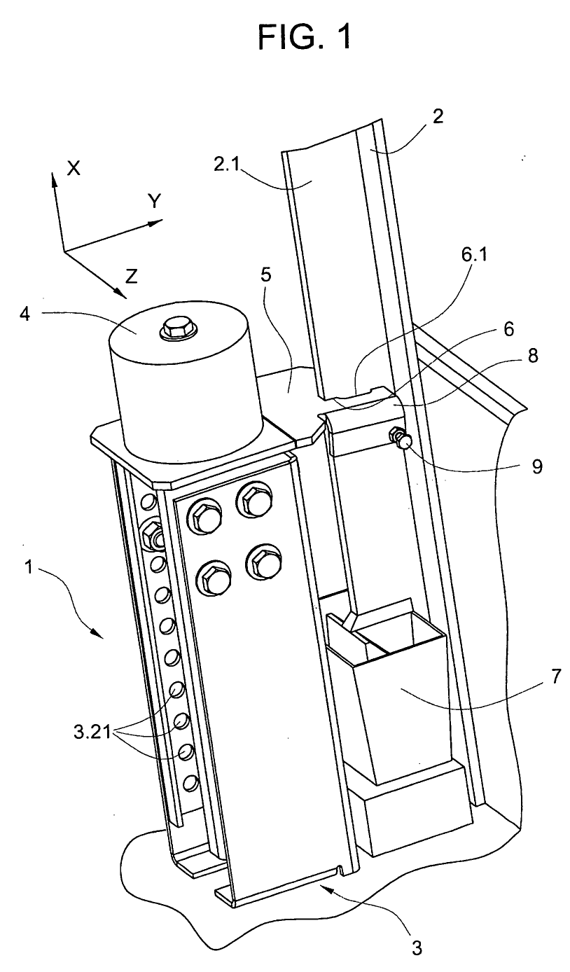

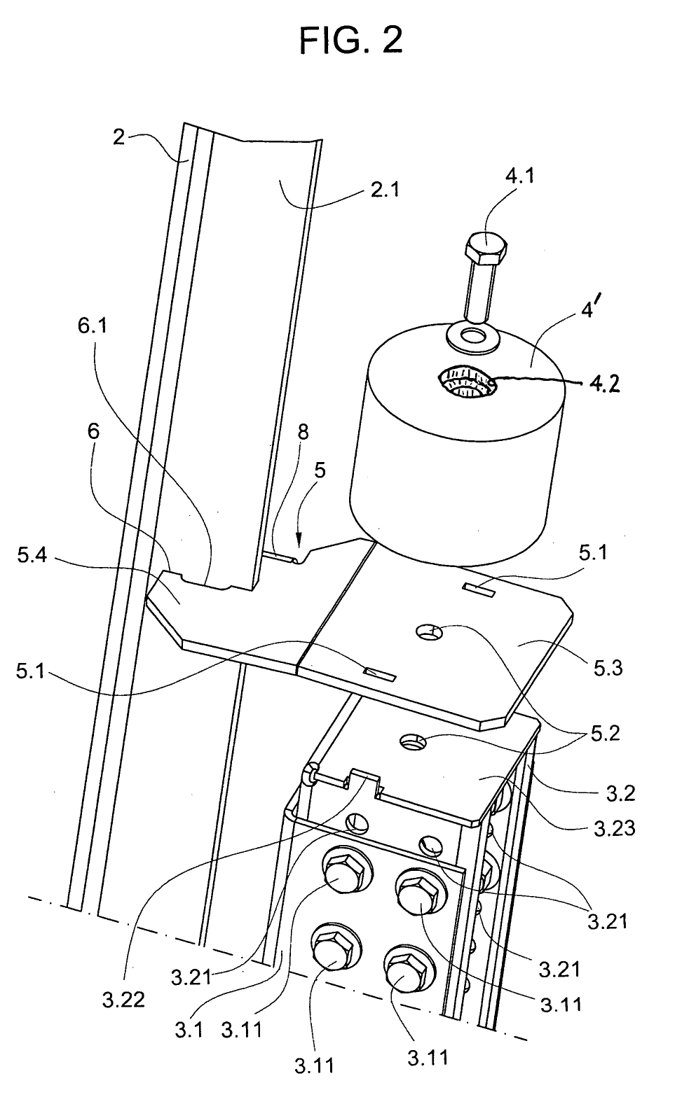

FIG. 1 shows a portion of a shaft pit 1 with at least one guide rail 2 supported in the shaft pit 1 and at least one buffer support 3, which is supported in the shaft pit 1, with a buffer 4 mounted thereon. The guide rail 2 and the buffer support 3 are connected by means of a plate 5, which produces a rigid unit of the buffer support and the guide rail. The plate 5 has a rectangular recess 6 which fits on the narrow side of the guide rail 2. The plate 5 can be pushed by the recess 6 onto a free limb 2.1 of the guide rail 2. The recess 6 has at both sides of the free limb 2.1 an offset 6.1 which serves for conducting away the lubricating oil, whereby the lubricating oil passes downwardly into a lubricating oil collector 7. As shown in FIG. 2, the plate 5 is slightly bent downwardly in the rail region so that the lubricating oil collecting on the plate 5 can in every case flow in the direction of the offset 6.1. Moreover, the plate 5 has in the rail region a bent-over portion 8 at which a screw 9 is arranged. The plate 5 is fixed in the “Y” direction by means of the screw 9, in the “Z” direction by means of the recess 6 and in the “X” direction by means of the buffer support 3.

FIG. 2 shows details of the connection, which is produced by means of the plate 5, between guide rail 2 and buffer support 3. The buffer support 3 consists of a housing 3.1 in which a support element 3.2 is arranged. The housing 3.1 and the support element 3.2 have a U-shaped cross-section. For adjustment of the buffer 4 in height the support element 3.2 has hole rows 3.21 which coincide with bores of the housing 3.1, wherein screws 3.11 connect the support element 3.2 with the housing 3.1. Lugs 3.22 which fit in slots 5.1 of the plate 5 and secure the plate 5 against rotation are arranged at the support element 3.2. Moreover, a cover 3.23, to which the buffer 4 is fastenable by means of a screw 4.1, is provided at the support element 3.2, wherein the screw 4.1 penetrates the bore 5.2 of the plate 5 and of the lid 3.23. The head of the screw 4.1 and a washer are exposed above the upper surface of the buffer 4 shown in FIG. 1. In FIG. 2, a buffer 4′ is provided with a counterbore 4.2 to recess the head of the screw 4.1 and the washer below the upper surface of the buffer 4′.

The plate 5 consists of a support part 5.3 and a rail part 5.4, which is slightly bent away downwardly relative to the support part 5.3, with the recess 6. Due to the slight inclination of the rail part 5.4 the lubricating oil, which collects on the plate 5, of the guide rail 2 flows away in every case in the direction of the offset 6.1 and passes downwardly into the lubricating oil collector 7.

The guide rail 2 and the buffer support 3 with the buffer 4 are provided for the elevator car or for the counterweight.

In accordance with the provisions of the patent statutes, the present invention has been described in what is considered to represent its preferred embodiment. However, it should be noted that the invention can be practiced otherwise than as specifically illustrated and described without departing from its spirit or scope.

1. Shaft pit equipment includes at least one buffer support and a buffer for use with an elevator car or a counterweight, wherein the buffer support and the buffer introduce forces that arise from buffer travel into a shaft pit, and at least one guide rail that is supported in the shaft pit for guiding the elevator car or the counterweight, wherein the rail forces which arise are introduced into the shaft pit, comprising:
a connection adapted to extend between and be attached to the buffer support and the guide rail, whereby when said connection is attached to the buffer support and the guide rail, a stiff unit is formed by the connection, the buffer support and the guide rail.

2. The equipment according to claim 1 wherein said connection includes a plate having a support part adapted to attach to the buffer support and a rail part adapted to attach to the guide rail.

3. The equipment according to claim 2 wherein said rail part includes a bent-over portion with a recess with offsets formed in said bent-over portion.

4. The equipment according to claim 3 including a screw for fixing said plate to the guide rail is mounted at said bent-over portion.

5. The equipment according to claim 2 including slots for accepting lugs of the buffer support are provided in said support part.

6. The equipment according to claim 2 wherein said rail part is slightly bent away downwardly relative to said support part and whereby lubricating oil that collects on said plate from the guide rail flows away from said support part

7. The equipment according to claim 6 including at least one offset formed in said rail part for passing the lubricating oil into a lubricating oil collector positioned below said plate.

8. Shaft pit equipment for an elevator comprising:
a buffer support and a buffer adapted to be mounted in an elevator shaft pit for contact by an elevator car or a counterweight, wherein said buffer support and said buffer introduce forces that arise from buffer travel into the shaft pit when installed;
a guide rail adapted to be supported in the shaft pit for guiding the elevator car or the counterweight, wherein the rail forces which arise are introduced into the shaft pit when said guide rail is installed; and
a connection extending between and attached to said buffer support and said guide rail, whereby a stiff unit is formed by said connection, said buffer support and said guide rail.

9. The equipment according to claim 8 wherein said connection includes a plate having a support part attached to said buffer support and a rail part attached to said guide rail.

10. The equipment according to claim 9 wherein said rail part includes a bent-over portion having a recess into which a free limb of said guide rail extends.

11. The equipment according to claim 9 wherein said rail part includes a bent-over portion and a screw mounted at said bent-over portion fixing said plate to said guide rail.

12. The equipment according to claim 9 including slots formed in said support part accepting lugs of said buffer support.

13. The equipment according to claim 9 wherein said rail part is slightly bent away downwardly relative to said support part and whereby lubricating oil that collects on said plate from said guide rail flows away from said support part

14. The equipment according to claim 13 including at least one offset formed in said rail part for passing the lubricating oil into a lubricating oil collector positioned below said plate.

15. Shaft pit equipment for an elevator comprising:
a buffer support and a buffer adapted to be mounted in an elevator shaft pit for contact by an elevator car or a counterweight, wherein said buffer support and said buffer introduce forces that arise from buffer travel into the shaft pit when installed;
a guide rail adapted to be supported in the shaft pit for guiding the elevator car or the counterweight, wherein the rail forces which arise are introduced into the shaft pit by said guide rail when installed;
a connection extending between and attached to said buffer support and said guide rail, whereby a stiff unit is formed by said connection, said buffer support and said guide rail, at least one offset being formed in said connection for passing lubricating oil through said connection; and
a lubricating oil collector positioned below said connection for collecting the lubricating oil.
